(19) United States
(12) Patent Application Publication
(10) Pub. No.: US 2016/0300163 A1
(43) Pub. Date: Oct. 13, 2016

(54) PROCESS AND APPARATUS FOR MATCHING AND ASSIGNING ONE OR MORE PARTIES WITH A TRANSPORTATION SERVICE PROVIDER

(71) Applicant: OPOLI TECHNOLOGY, INC., Hawthorne, CA (US)

(72) Inventors: Rattan Joea, Simi Valley, CA (US); Robert Gibson, Fontana, CA (US)

(73) Assignee: OPOLI TECHNOLOGY, INC.

(21) Appl. No.: 15/075,564

(22) Filed: Mar. 21, 2016

Related U.S. Application Data
(60) Provisional application No. 62/144,822, filed on Apr. 8, 2015.

(51) Int. Cl. G06Q 10/02; G06Q 30/02; G06Q 50/30

(52) U.S. Cl. CPC G06Q 10/02; G06Q 50/30; G06Q 30/0201

(57) ABSTRACT

One or more parties may be matched and assigned with a transportation service provider. The amount of time it takes for transporting the first party from one location to another is determined, and the additional amount of time it takes to pick up a potential party or parties is determined. Using this determination, the potential party or parties may be assigned to the transportation service provider. This way, multiple parties can be transported together in the same vehicle in a quick and efficient manner without any human intervention.

### CROSS-REFERENCE TO RELATED APPLICATION

This application claims the benefit of U.S. Provisional Application No. 62/144,822, filed on Apr. 8, 2015. The subject matter thereof is hereby incorporated herein by reference in its entirety.

### FIELD

The present invention relates to transporting one or more parties, and more particularly, to determining whether one or more parties can be matched together for transportation without human intervention.

### BACKGROUND

Generally, when one or more persons or parties request transportation services, a dispatcher must be involved to coordinate, route, and dispatch a vehicle to service these one or more persons or parties. For example, the dispatcher may use different tools, as well as his or her own knowledge and experience, to determine travel time estimates and decide how long a multi-stop trip will take. This process introduces inconsistency in service and requires a higher operating overhead for the company providing the transportation.

Other automated processes may be used to alleviate this problem. Conventional automated processes determine the route(s) a transportation vehicle will take to go from one location to another, and if the route(s) and timing match for each party, then the two parties are packaged together. However, such processes fail to take into account the amount of time it takes to go from one location to another, including the additional time it takes to pick up the other party. As a result, the overall process to add parties to a transportation vehicle is inefficient.

Thus, an alternative approach may be beneficial.

### SUMMARY

Certain embodiments of the present invention may provide solutions to the problems and needs in the art that have not yet been fully identified, appreciated, or solved by current routing and dispatching systems. For example, in some embodiments, a routing and dispatching system may determine the amount of time it takes for transporting a first party from one location to another, and an additional amount of time it would take to pick up a potential additional party or parties. This way, the routing and dispatching system may quickly and efficiently determine whether multiple parties can be transported together in the same vehicle without any human intervention, as well as setting clear expectations with the parties, i.e., the customers, as to the maximum amount of time their trip may take.

In one embodiment, a process for selecting a provider (or driver) from a list of providers may include receiving a request from a user device for a passenger pickup. The process may also include selecting a provider from the list of providers, and assigning a party to the selected provider, when a new route of the provider is less than a maximum allotted time.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a block diagram illustrating a computing system for matching one or more parties with a transportation service provider, according to an embodiment of the present invention.

FIGS. 2A-2C are flow diagrams illustrating a process for matching and assigning one or more parties with a transportation provider, according to an embodiment of the present invention.

FIGS. 3A-3D are flow diagrams illustrating a process for matching and assigning one or more parties with a transportation provider, according to an embodiment of the present invention.

FIG. 4 is a flow diagram illustrating a process for assigning a score to one or more drivers, according to an embodiment of the present invention.

### DETAILED DESCRIPTION OF THE EMBODIMENTS

Some embodiments of the present invention generally pertain to packaging parties together for transportation based on the amount of time it would take to go from one location to another and the additional amount of time it would take to pick up the additional party.

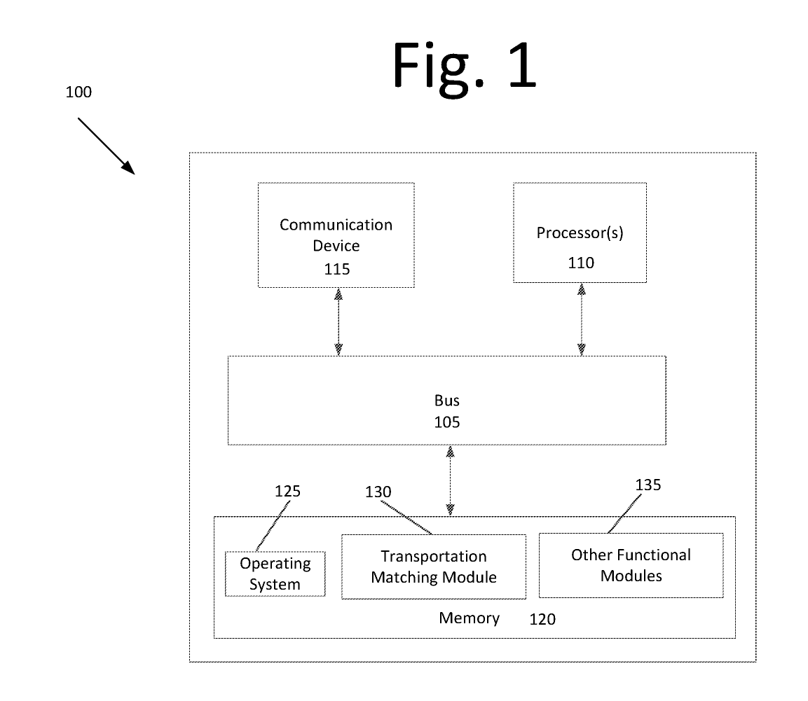

FIG. 1 is a block diagram illustrating a computing system 100 for matching one or more parties with a transportation service provider, according to one embodiment of the present invention. Computing system 100 includes a bus 105 or other communication mechanism configured to communicate information, and at least one processor 110, coupled to bus 105, to process information. At least one processor 110 can be any type of general or specific purpose processor. Computing system 100 also includes memory 120 that stores information and instructions to be executed by at least one processor 110. Memory 120 can be comprised of any combination of random access memory (“RAM”), read only memory (“ROM”), static storage such as a magnetic or optical disk, or any other type of computer readable medium. Computing system 100 also includes a communication device 115, such as a network interface card, that may provide access to a network.

The computer readable medium may be any available media that can be accessed by at least one processor 110. The computer readable medium may include both volatile and nonvolatile medium, removable and non-removable media, and communication media. The communication media may include computer readable instructions, data structures, program modules, or other data and may include any information delivery media.

According to one embodiment, memory 120 may store software modules that may provide functionality when executed by at least one processor 110. The modules include an operating system 125 and a transportation matching module 130 for matching one or more parties with a transportation service provider, as well as other functional modules 135. Operating system 125 may provide operating system functionality for computing system 100. Because computing system 100 may be part of a larger system, computing system 100 may include one or more additional functional modules 135 to include the additional functionality.

One skilled in the art will appreciate that a “system” could be embodied as a personal computer, a server, a console, a personal digital assistant (PDA), a cell phone, a tablet computing device, or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

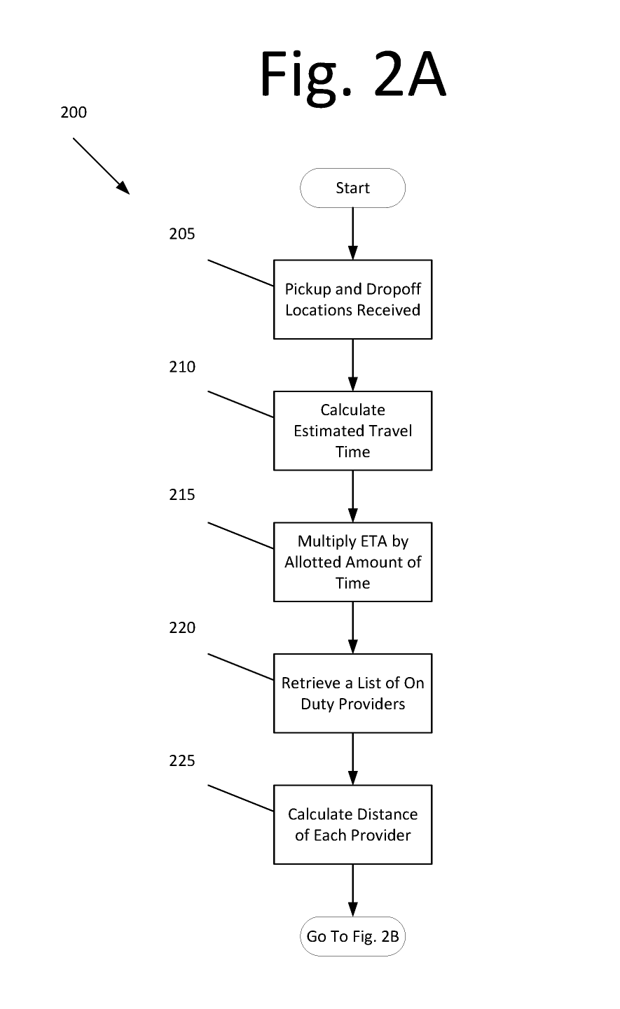

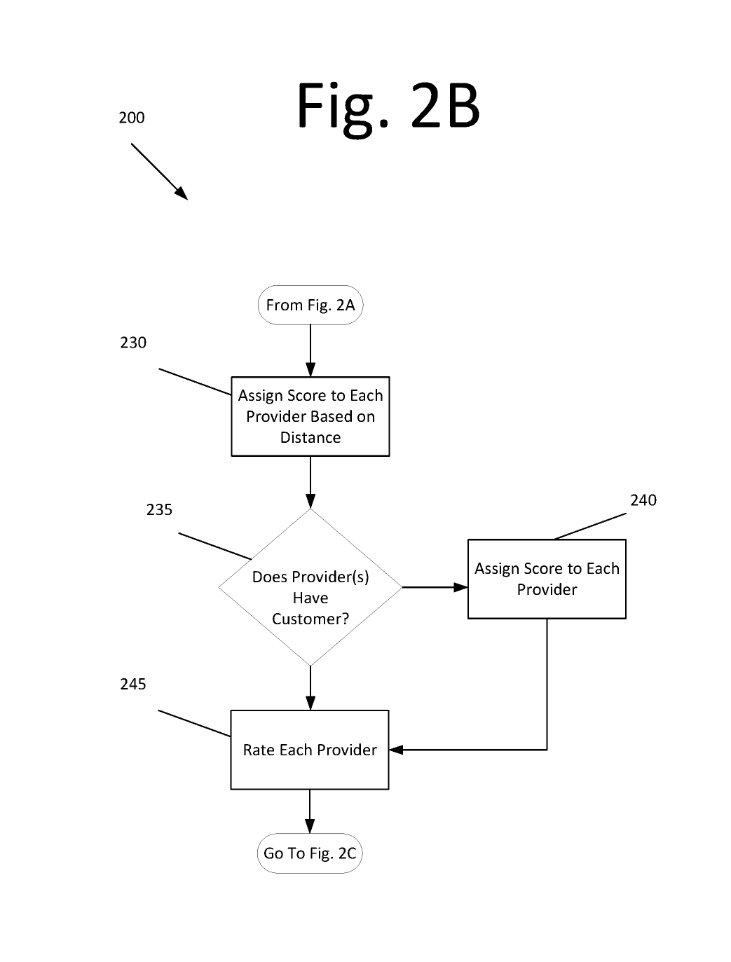

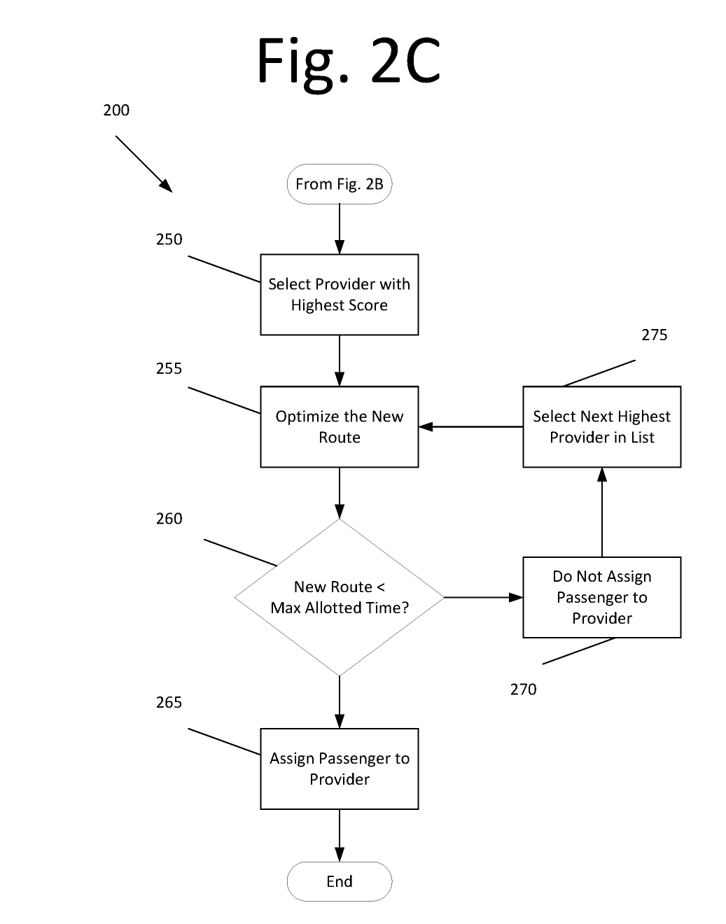

FIGS. 2A-2C are flow diagrams 200 illustrating a process for matching and assigning one or more parties with a transportation provider, according to an embodiment of the present invention. In some embodiments, the process may be executed by the computing system of FIG. 1, for example. In an embodiment, the process begins at 205 with the computing system receiving a pickup location and drop off location from a party interested in obtaining transportation services. In some embodiments, a party may include one or more passengers interested in obtaining transportation services. At 210, the computing system calculates an estimated travel time X between the drop off location and the pickup location. The estimated travel time X in some embodiments may indicate the amount of time it would take from picking up the party to dropping off the party. At 215, the process multiplies the estimated travel time X by an allotted amount of time multiplier Y to determine the maximum amount of time Z allowable for the party to reach his or her destination. In some embodiments, the allotted amount of time multiplier Y may be preset to a specific number, e.g., 100 percent (to cover twice of amount of estimate travel time), 150 percent (to cover more than twice amount of estimate travel time), etc. At 220, a list of all on-duty providers within a predefined distance from the party's pickup location is determined and retrieved, and at 225, the distance of each provider to the party's pickup location is calculated.

At 230, based on the calculated distance of each provider, a score F is assigned to each provider. At 235, it is determined whether one or more providers are carrying one or more existing parties (or customers). Customers in some embodiments may include one or more passengers. For each provider that has one or more customers, a score G is assigned to the one or more providers with the one or more customers at 240. Otherwise, at 245, each provider is ranked (or rated) based on score F and/or score G (e.g., score F plus score G). The providers may be ranked in the order of who is best suited to perform the pickup.

At 250, using the ranking of the providers, the provider with the highest score is selected. At 255, a new route W is optimized with a new estimated time of arrival for each party in the potential trip. In other words, any existing customer in the trip that a provider is currently assigned to is considered, and then the new party is added in to optimize the new route W.

At 260, it is determined whether the new optimized route W is less than the maximum allotted amount of time Z for all parties in the trip. In some embodiments, estimated travel time X multiplied by allotted amount of time multiplier Y equals to maximum allotted amount of time Z. If the new optimized route W is less than the maximum allotted amount of time Z for all parties in the trip, then the party is assigned to the provider at 265. Otherwise, at 270, the party is not assigned to the provider, and at 275, the provider with the next highest ranking in the list is selected, and a new route is optimized.

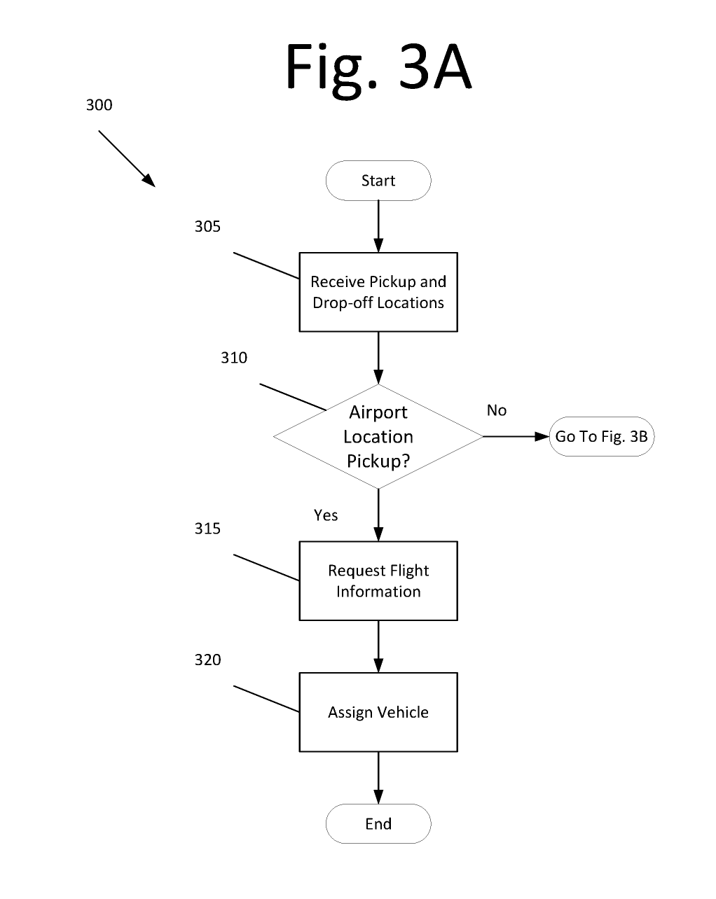

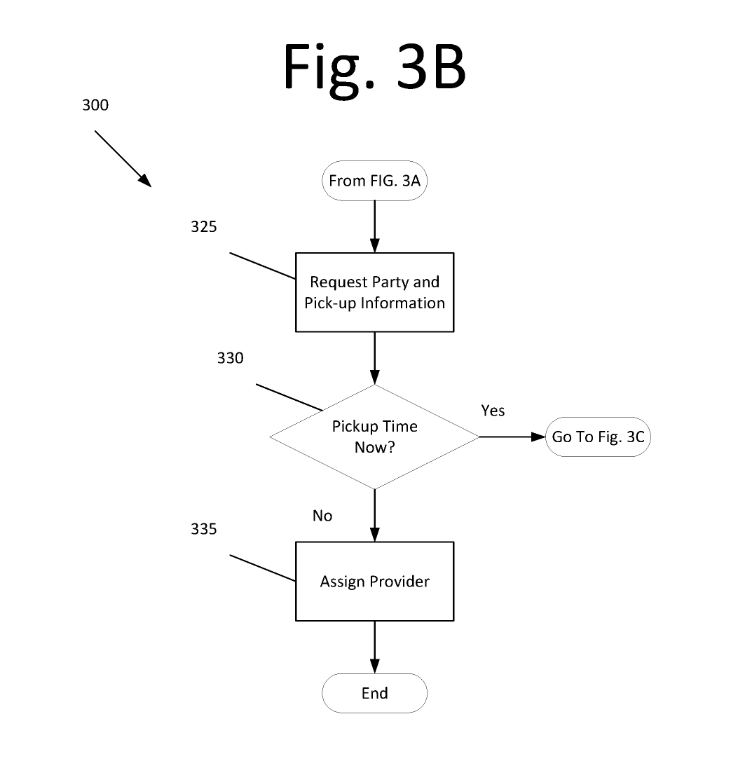

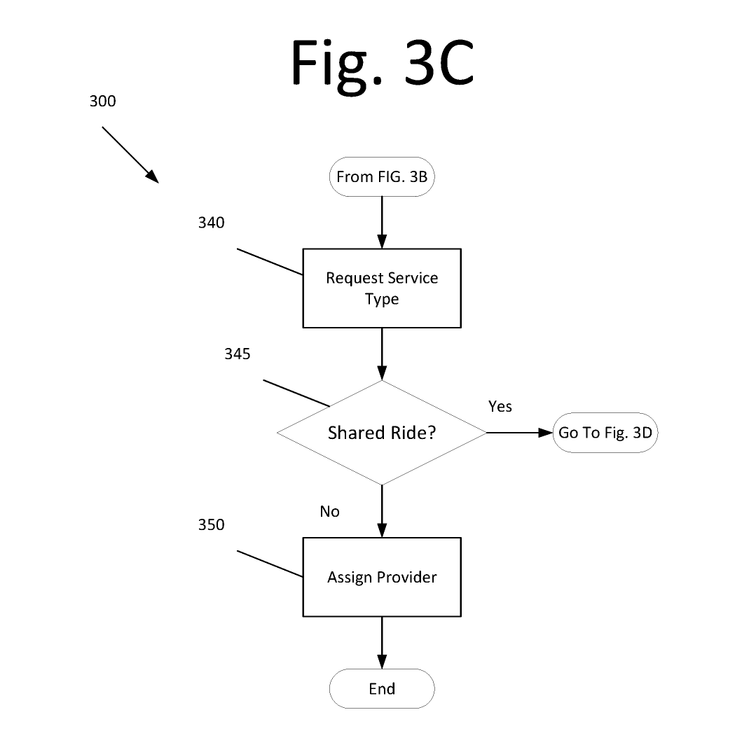

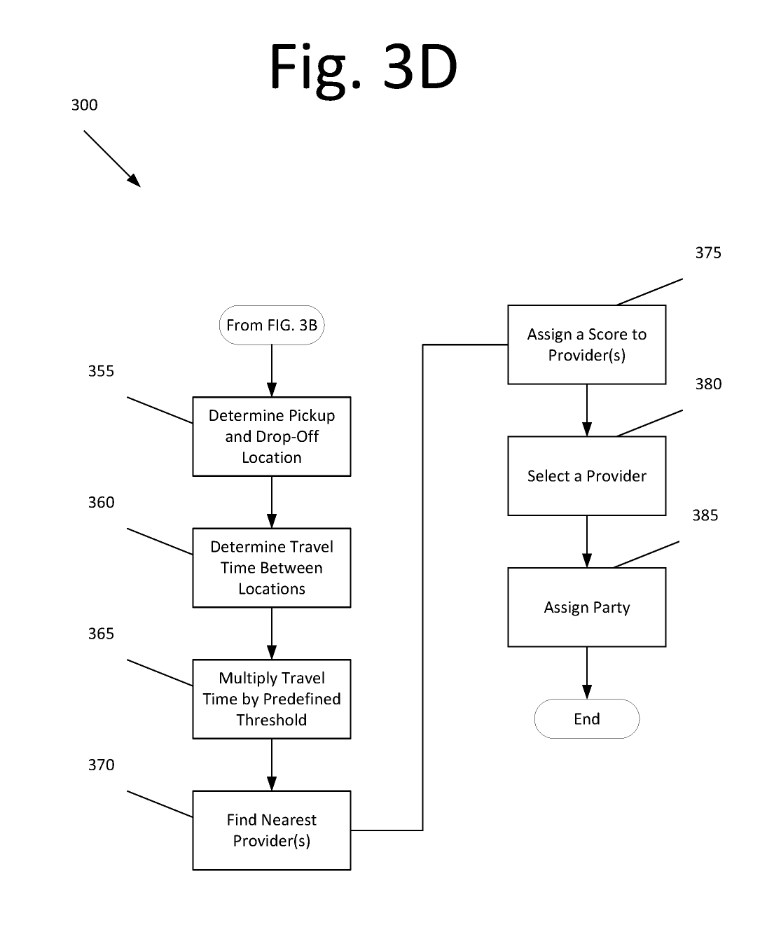

FIGS. 3A-3D are flow diagrams 300 illustrating a process for matching and assigning one or more parties to a transportation provider, according to an embodiment of the present invention. In some embodiments, the process of FIG. 3 may be executed by the computing system of FIG. 1, for example. In an embodiment, the process begins at 305 with the computing system receiving pickup (or current) location and drop-off (or destination) location from a user of another computing device, such as a mobile phone or tablet. Along with pickup and drop-off locations, the computing system may also receive information such as airport pickup, share ride request, private shuttle or car request, etc. For purposes of explanation, the user may be a party requesting transportation services, and the party may include one or more passengers.

At 310, the computing system may determine whether the pickup location is at an airport. If the pickup location is at an airport, then the computing system at 315 requests flight information, and upon receipt of the flight information, the computing system assigns the party with a provider (or driver) at 320. In some embodiments, the computing system may receive flight information along with pickup and drop-off locations, enabling step 315 to be bypassed and the provider is assigned to the party.

If the pickup location is not at an airport, the computing system at 325 may request party and pickup information. Party and pickup information may include the number of passengers and the time of pickup. Upon receipt of the party and pickup information, the computing system determines at 330 whether the pickup time is immediate or at a future date and/or time. If the pickup is for a later date and/or time, then the computing system at 335 may store the pickup information until the later date and time for dispatching.

If, however, the computing system determines that the pickup time is immediate or within a predefined time period, the computing system at 340 requests service type information from the other computing device. Service type information may include shared ride, private ride, etc. Upon receipt of the service type information, the computing system at 345 determines whether the party is requesting a share ride service or a private ride service. If the computing system determines that the party is requesting a private ride service, then the computing system at 350 assigns the party with a provider.

If, however, the computing system determines that the party is requesting a shared ride service, the computing system at 355 determines the distance between the pickup location and drop-off location. At 360, the computing system determines the travel time between the pickup location and drop-off location, and at 365, multiplies the travel time by a predefined threshold to determine the maximum allotted amount of time, as discussed above.

The computing system at 370 finds the nearest provider or providers based on the distance, travel time, and multiplied travel time, and at 375, assigns a score to the one or more providers.

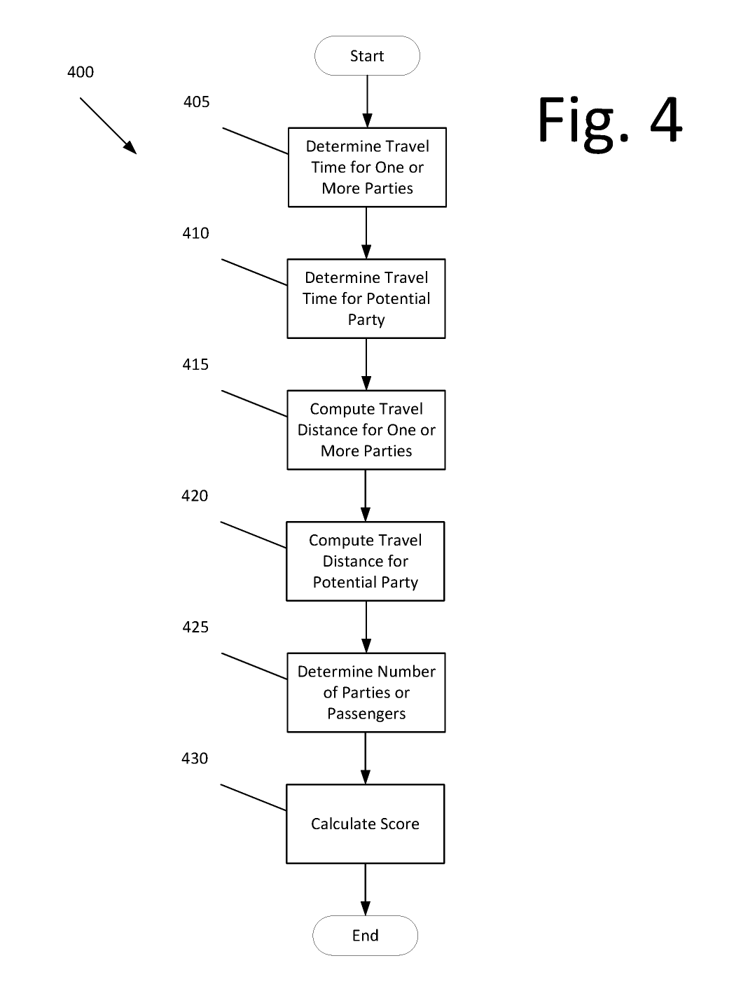

FIG. 4 is a flow diagram illustrating a process for assigning a score to one or more drivers, according to an embodiment of the present invention. In some embodiments, the process of FIG. 4 may be executed by the computing system of FIG. 1, for example. In an embodiment, the process begins at 405 with the computing system determining travel time for one or more parties. This may include the travel time for each party currently assigned to a driver of the vehicle. Travel time in certain embodiments includes the time to travel from a first location to a second location. At 410, the computing system determines the travel time for the potential party that will be assigned to the driver of the vehicle.

At 415, the travel distance for each party currently assigned to the driver of the vehicle is calculated, and at 420, the travel distance for the potential party that will be assigned to the driver of the vehicle is also calculated in an embodiment. At 425, the computing system may determine the total number of parties already included in the driver's vehicle.

At 430, a score is calculated based on the travel time for the one or more parties, the travel time for the potential party, the travel distance for the one or more parties, the travel distance for the potential party, and the number of passengers already included within the driver's vehicle. In some embodiments, a higher score may be assigned to a driver's vehicle when the driver's vehicle includes a greater number of parties already included within the driver's vehicle.

The process of FIG. 4 may be executed for each driver that is proximate to the potential party. Returning to FIG. 3D, at 380, the computing system may select the provider, i.e., the driver, with the highest score, and at 385, assign the party to the provider in some embodiments. Once the party is assigned to the provider, the provider and/or the party may receive a notification informing them of the match.

In some embodiments, once the provider with the highest score is selected, an optimization of the route may be calculated to determine if the selected provider is best suited for the party or if another provider should be selected instead. See, for example, FIG. 2C. Once route optimization is completed and the determination is made, the party may then be assigned to the provider.

The processes shown in FIGS. 2A-4 may be performed, in part, by a computer program, encoding instructions for a nonlinear adaptive processor to cause at least the processes described in FIGS. 2A-4 to be performed by the apparatuses discussed herein. The computer program may be embodied on a non-transitory computer readable medium. The computer readable medium may be, but is not limited to, a hard disk drive, a flash device, a random access memory, a tape, or any other such medium used to store data. The computer program may include encoded instructions for controlling the nonlinear adaptive processor to implement the processes described in FIGS. 2A-4, which may also be stored on the computer readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, or an application specific integrated circuit (“ASIC”).

It should be appreciated that current processes are typically manual. For example, current processes requires a human to use different tools and his or her knowledge and experience to determine travel estimates and make decisions about how long multi-stop trips will take. Other automated processes determine the route(s) a service provider would typically take to go from one location to another, and if the route and timing line up with another passenger, then the passenger and the service provider are packaged together.

Embodiments discussed herein, however, calculate the amount of time that it would take to go from one location to another, and how much additional time it would take to pick up one or more additional passengers. This lowers operating cost since an automated system is used rather than human labor.

Simply put, the embodiments described herein allow a transportation company to not only lower their operating cost by having using this automated system, but also improve the processing speed at which a party is assigned to a provider. Existing systems are inefficient and may not provide effectively assign a passenger to provider. This is because in order to route passengers together in existing automatic dispatching services, both the route and timing have to align perfectly. In the embodiments described herein, however, only the timing may need be in alignment. Thus, as passenger density grows, efficiency will improve as well.

It will be readily understood that the components of various embodiments of the present invention, as generally described and illustrated in the figures herein, may be arranged and designed in a wide variety of different configurations. Thus, the detailed description of the embodiments, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A process for selecting a provider from a list of providers, comprising:
receiving a request from a user device for a passenger pickup;
selecting a provider from the list of providers; and
assigning a party to the selected provider, when a new route of the provider is less than a maximum allotted time.

2. The process of claim 1, further comprising:
optimizing the new route for transporting the party and one or more existing parties, wherein
the new route comprises an estimated time of arrival for the party and one or more existing parties.

3. The process of claim 1, wherein the maximum allotted time comprises an estimated travel time for the party and an allotted amount of time multiplier.

4. The process of claim 3, wherein the estimated travel time for the party comprises a travel time from picking up the party to dropping off the party.

5. The process of claim 3, wherein the allotted amount of time multiplier comprises a number greater than an estimated travel time.

6. The process of claim 1, wherein the list of providers comprises a plurality of providers within a predefined distance of the user device.

7. The process of claim 1, wherein the selecting of the provider from the list of providers comprises
rating each provider in the list of providers based on an assigned score.

8. The process of claim 1, wherein the assigned score for each provider depends on a distance between each of the providers and the party and a number of passengers within a vehicle of each provider.

9. A process for assigning a party to a transportation provider, comprising:
receiving a request from a user device of the party for a passenger pickup;
searching for one or more transportation providers within a predefined distance to a location of the user device;
assigning the party to the transportation provider selected from the one or more transportation providers based on a score and a travel time for the party and one or more existing parties.

10. The process of claim 9, further comprising:
determining a pickup location and a drop off location for the party;
determining a total time for travel between the pickup location and the drop off location for the party; and
multiply the total time for travel by a predefined threshold percentage or number.

11. The process of claim 10, wherein the searching of the one or more transportation providers comprises:
populating a list for the one or more transportation providers based on a distance between the one or more transportation providers and the user device and a travel time to pick up the party at the location of the user device.

12. The process of claim 11, further comprising:
determining a travel time for each party currently assigned to the one or more transportation providers.

13. The process of claim 12, further comprising:
assigning a score to the one or more transportation providers based on the total time for travel for the party, the travel time for each party, and a number of parties currently assigned to the one or more transportation providers.

14. The process of claim 13, wherein the number of parties has a greater weight than the total time for travel for the party and the travel time for each party.

15. The process of claim 13, further comprising:
selecting a transportation provider from the list of one or more transportation providers, the transportation provider with a highest score is selected;
optimizing a new route for the selected transportation provider; and
determining whether the optimized new route is less than a maximum allotted time.

16. The process of claim 15, wherein the optimized new route comprises the travel time for the currently assigned parties and the party of the user device requesting pickup.
